(19) United States
(12) Patent Application Publication
(10) Pub. No.: US 2019/0163837 A1
(43) Pub. Date: May 30, 2019

(54) DIGITAL DATA FILTERING METHOD, APPARATUS, AND TERMINAL DEVICE

(71) Applicant: UBTECH Robotics Corp, Shenzhen (CN)

(72) Inventors: YOUJUN XIONG, Shenzhen (CN); Haiwu Su, Shenzhen (CN); Lin Chen, Shenzhen (CN)

(21) Appl. No.: 15/984,419

(22) Filed: May 21, 2018

(30) Foreign Application Priority Data
Nov. 30, 2017 (CN) 201711234696.4

(51) Int. Cl. G06F 17/30

(52) U.S. Cl. CPC G06F 17/30967; G01C 3/08

(57) ABSTRACT

The present disclosure provides a digital data filtering method and apparatus. The method includes: collecting first digital data and second digital data of a current collection period; obtaining a current digital sample data by summing the first digital data and the second digital data and obtaining an arithmetic mean; determining a data change trend of the current digital sample data according to the current digital sample data and a digital sample data of a previous collection period; and determining a filtering method according to the data change trend, and filtering the current digital sample data using the filtering method to obtain a filtered data. The present disclosure can realize the filtering of digital data in different interference scenes, which improves the anti-interference capability of digital data filtering.

### CROSS REFERENCE TO RELATED APPLICATIONS

This application claims priority to Chinese Patent Application No. 201711234696.4, filed Nov. 30, 2017, which is hereby incorporated by reference herein as if set forth in its entirety.

### BACKGROUND

### 1. Technical Field

The present disclosure relates to data processing technology, and particularly to a digital data filtering method, apparatus, and terminal device.

### 2. Description of Related Art

There are various infrared sensors disposed on a robot to collect various infrared data of the surrounding environment. The collected infrared data needs to be filtered due to noise, so as to improve the reliability of the data.

At present, the conventional infrared data filtering methods generally use complex high level digital filtering, which is too monotonous in data processing. As a result, the anti-interference capability and the adaptability of infrared data filtering is poor since complex high level digital filtering is always adopted in spite of the differences between the interference scenarios where the infrared data is obtained.

### BRIEF DESCRIPTION OF THE DRAWINGS

To describe the technical schemes in the embodiments of the present disclosure more clearly, the following briefly introduces the drawings required for describing the embodiments or the prior art. Apparently, the drawings in the following description merely show some examples of the present disclosure. For those skilled in the art, other drawings can be obtained according to the drawings without creative efforts.

FIG. 1 is a flow chart of a digital data filtering method according to an embodiment of the present disclosure.

FIG. 2 is a flow chart of a digital data filtering method according to another embodiment of the present disclosure.

FIG. 3 is a flow chart of a digital data filtering method according to still another embodiment of the present disclosure.

FIG. 4 is a flow chart of a digital data filtering method according to the other embodiment of the present disclosure.

FIG. 5 is a schematic diagram of a digital data filtering apparatus according to the other embodiment of the present disclosure.

FIG. 6 is a schematic diagram of a digital data filtering terminal device according to the other embodiment of the present disclosure.

### DETAILED DESCRIPTION

In the following descriptions, for purposes of explanation instead of limitation, specific details such as particular system architecture and technique are set forth in order to provide a thorough understanding of embodiments of the present disclosure. However, it will be apparent to those skilled in the art that the present disclosure may be implemented in other embodiments that are less specific of these details. In other instances, detailed descriptions of well-known systems, devices, circuits, and methods are omitted so as not to obscure the description of the present disclosure with unnecessary detail.

It is to be understood that, when used in the description and the appended claims of the present disclosure, the terms “including” and “comprising” indicate the presence of stated features, integers, steps, operations, elements and/or components, but do not preclude the presence or addition of one or a plurality of other features, integers, steps, operations, elements, components and/or combinations thereof.

It is also to be understood that, the terminology used in the description of the present disclosure is only for the purpose of describing particular embodiments and is not intended to limit the present disclosure. As used in the description and the appended claims of the present disclosure, the singular forms “a,” “an,” and “the” are intended to include the plural forms as well, unless the context clearly indicates otherwise.

It is also to be further understood that the term “and/or” used in the description and the appended claims of the present disclosure refers to any combination of one or more of the associated listed items and all possible combinations, and includes such combinations.

As used in the description and the appended claims, the term “if” may be interpreted as “when” or “once” or “in response to determining” or “in response to detecting” according to the context. Similarly, the phrase “if determined” or “if [the described condition or event] is detected” may be interpreted as “once determining” or “in response to determining” or “on detection of [the described condition or event]” or “in response to detecting [the described condition or event]”.

For the purpose of describing the technical solutions of the present disclosure, the following describes through specific embodiments.

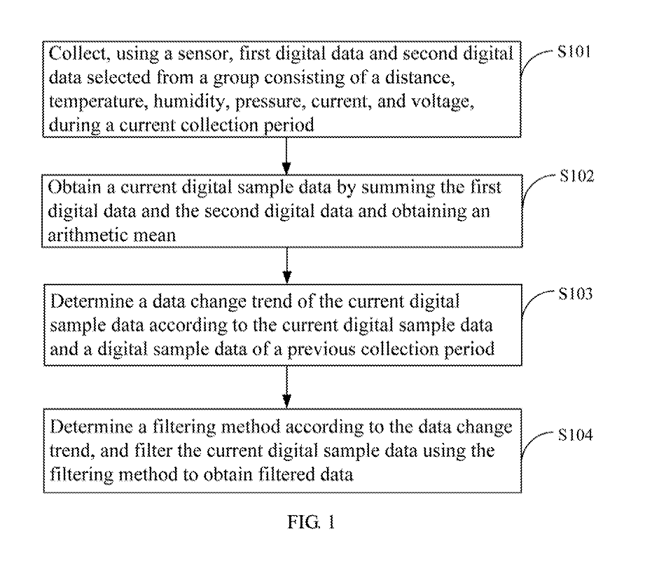

FIG. 1 is a flow chart of a digital data filtering method according to an embodiment of the present disclosure. In this embodiment, the method is a computer-implemented method executable for a processor. The method can be applied to a robot equipped with sensors, such as infrared sensors, ultrasound sensors, or laser sensors. As shown in FIG. 1, the method includes the following steps.

S101: collecting first digital data and second digital data of a current collection period.

In this embodiment, it is determined whether the first digital data or the second digital data exceeds a preset threshold range. If the first digital data or the second digital data exceeds the preset threshold range, the first digital data or the second digital data (which exceeds the preset threshold range) is discarded and reobtained. In this embodiment, the first digital data and the second digital data are Double type or Integer type, and are obtained by the sensors of the robot. In this embodiment, the first digital data and the second digital data are data of distances obtained by infrared sensors. In other embodiments, the first digital data and the second digital data can be other type of digital data such as temperature, humidity, pressure, current, or voltage data.

Specifically, the preset threshold range includes a maximum threshold Dmax and a minimum threshold Dmin. When the first digital data or the second digital data is greater than the maximum threshold Dmax or less than the minimum threshold Dmin, the first digital data or the second digital data (which exceeds the preset threshold range) is discarded and reobtained.

S102: obtaining a current digital sample data by summing the first digital data and the second digital data and obtaining an arithmetic mean.

In this embodiment, the current digital sample data Dn=(D1n+D2n)/2, where D1n is the first digital data of the current collection period, and D2n is the second digital data of the current collection period.

S103: determining a data change trend of the current digital sample data according to the current digital sample data and a digital sample data of a previous collection period.

In this embodiment, the data change trend may include data change direction and data change acceleration. In addition, the digital sample data of the previous collection period is Double type or Integer type, and are obtained by the sensors of the robot. In this embodiment, the digital sample data of the previous collection period is data of distances obtained by infrared sensors. In other embodiments, the digital sample data of the previous collection period can be other type of digital data such as temperature, humidity, pressure, current, or voltage data.

S104: determining a filtering method according to the data change trend, and filtering the current digital sample data using the filtering method to obtain filtered data.

The filtered data may be output to the robot for, for example, operating (e.g., moving) the robot based on the filtered data. In this embodiment, different filtering methods are used according to different data change trends.

It can be known from this embodiment that the present disclosure can realize the filtering of digital data in different interference scenes which improves the anti-interference capability of digital data filtering by: collecting first digital data and second digital data of a current collection period; obtaining a current digital sample data by summing the first digital data and the second digital data and obtaining an arithmetic mean; determining a data change trend of the current digital sample data according to the current digital sample data and a digital sample data of a previous collection period; and determining a filtering method according to the data change trend, and filtering the current digital sample data using the filtering method to obtain filtered data. The digital data filtering method can be applied in, for example, confirming whether there is an obstacle in front of a robot. In an obstacle detection process, the obtained data are filtered first, and then determining whether the filtered data is lesser than a threshold. If yes, it is determined that there is an obstacle in front of a robot.

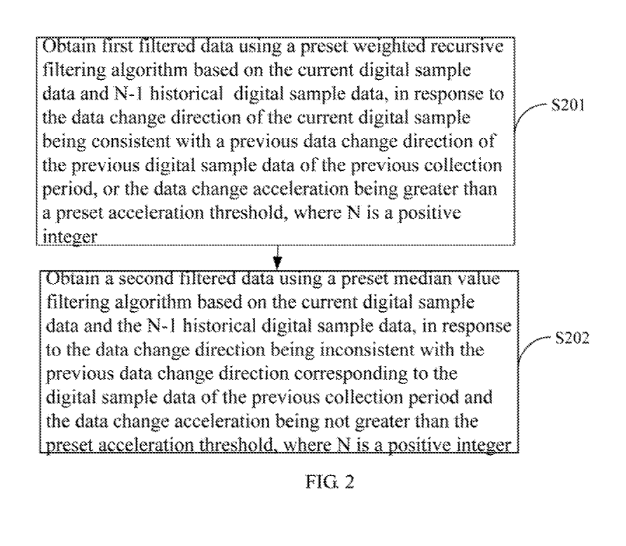

FIG. 2 is a flow chart of a digital data filtering method according to another embodiment of the present disclosure. In this embodiment, the data change trend includes a data change direction and the data change acceleration. As shown in FIG. 2, the above-mentioned step S104 includes the following steps.

S201: obtaining first filtered data using a preset weighted recursive filtering algorithm based on the current digital sample data and N−1 historical digital sample data, if the data change direction is consistent with a previous data change direction corresponding to the digital sample data of the previous collection period, or the data change acceleration is greater than a preset acceleration threshold, where N is a positive integer.

In this embodiment, the value of N is greater than 2. Preferably, N has the value of 10. The obtaining process of the pre-stored previous data change direction Fo (not shown) corresponding to the digital sample data of the previous collection period is the same as that of the data change direction Fn (not shown). When the directions of the data change direction Fn and the previous data change direction Fo are the same, or when the data change acceleration An (not shown) of the current digital sample data is greater than the preset acceleration threshold Ah (not shown), the first filtered data is calculated by using the preset weighted recursive filtering algorithm, in which the preset weighted recursive filtering algorithm may be any existing weighted recursive filtering algorithm. In this embodiment, the first filtered data and the historical digital sample data are Double type or Integer type, and are obtained by the sensors of the robot. In this embodiment, the first filtered data and the historical digital sample data are data of distances obtained by infrared sensors. In other embodiments, the first filtered data and the historical digital sample data can be other type of digital data such as temperature, humidity, pressure, current, or voltage data.

In this embodiment, the N−1 historical digital sample data may be stored historical filter output data, or may be digital sample data having the same value with the current digital sample data. Specifically, when it is possible to obtain the stored historical filter output data, it is determined that the N−1 historical digital sample data is the stored historical filter output data; when it is impossible to obtain the stored historical filter output data, it is determined that the N−1 historical digital sample data is the digital sample data having the same value with the current digital sample data.

In one embodiment of the present disclosure, assuming the current digital sample data is D_{N}, and the N−1 historical digital sample data are respectively D₁, D₂, . . . , and D_{N-1}, where D₁, D₂, . . . , and D_{N-1}, are in the order of collection;

determining first filtered data O, wherein

$$O = ( {\sum }_{i = 1}^{N} ki * {D}_{i} ) / {\sum }_{i = 1}^{N} ki ,$$

i is 1, 2, 3, . . . , and N, and weighting factor ki=2ⁱ, if the data change direction is consistent with the previous data change direction corresponding to the digital sample data of the previous collection period and the data change acceleration is greater than the preset acceleration threshold; and

determining the first filtered data O, wherein

$$O ( {\sum }_{i = 1}^{N} ki * {D}_{i} ) / {\sum }_{i = 1}^{N} ki ,$$

i is 1, 2, 3, . . . , and N, and weighting factor ki=i, if the data change direction is consistent with the previous data change direction corresponding to the digital sample data of the previous collection period and the data change acceleration is not greater than the preset acceleration threshold, or if the data change direction is inconsistent with the previous data change direction corresponding to the digital sample data of the previous collection period and the data change acceleration is greater than the preset acceleration threshold.

S202: obtaining second filtered data using a preset median value filtering algorithm based on the current digital sample data and the N−1 historical digital sample data, if the data change direction is inconsistent with the previous data change direction corresponding to the digital sample data of the previous collection period and the data change acceleration is not greater than the preset acceleration threshold, where N is a positive integer.

In this embodiment, when the directions of the data change direction Fn and the previous data change direction Fo are the same, and the data change acceleration An of the current digital sample data is not greater than the preset acceleration threshold Ah, a preset median value filtering algorithm is used to calculate the first filtered data, where the preset median value filtering algorithm may be any existing weighted recursive filtering algorithm.

In this embodiment, if the data change direction is consistent with the previous data change direction corresponding to the digital sample data of the previous collection period or the data change acceleration is greater than the preset acceleration threshold, the first filtered data is obtained using the preset weighted recursive filtering algorithm based on the current digital sample data and the N−1 historical digital sample data; if the data change direction is inconsistent with the previous data change direction corresponding to the digital sample data of the previous collection period and the data change acceleration is not greater than the preset acceleration threshold, the second filtered data is obtained using the preset median value filtering algorithm based on the current digital sample data and the N−1 historical digital sample data. Which can filterer digital data simply and quickly, so as to improve the efficiency of digital data filtering and reduce computational cost.

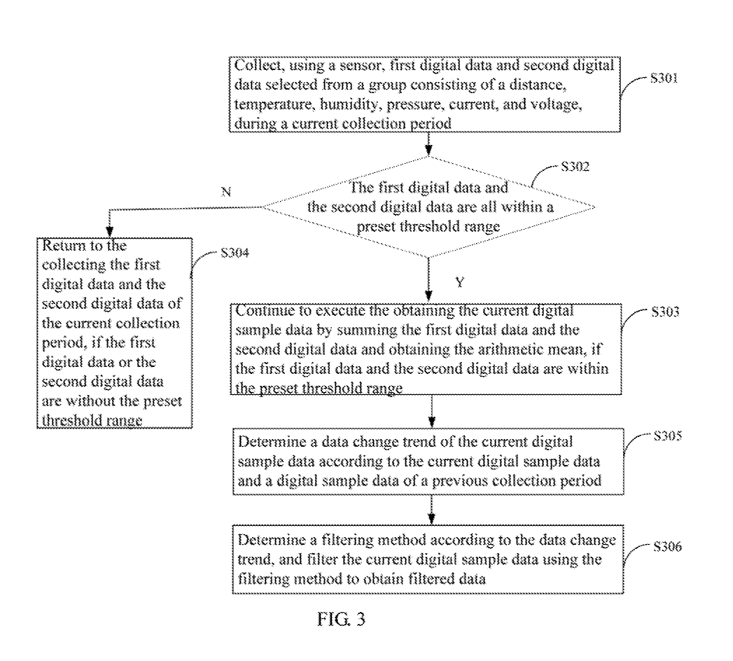

FIG. 3 is a flow chart of a digital data filtering method according to still another embodiment of the present disclosure. In this embodiment, the contents of step S301 is consistent with that of step S101, and the specific descriptions can refer to the related description of step S101 and are not described herein. As shown in FIG. 3, the method includes the following steps.

S302: determining whether the first digital data and the second digital data are all within a preset threshold range.

In this embodiment, it is determined whether the first digital data or the second digital data exceeds a preset threshold range. If the first digital data or the second digital data exceeds the preset threshold range, the first digital data or the second digital data (which exceeds the preset threshold range) is discarded and reobtained.

Specifically, the preset threshold range includes a maximum threshold Dmax and a minimum threshold Dmin. When the first digital data or the second digital data is greater than the maximum threshold Dmax or less than the minimum threshold Dmin, the first digital data or the second digital data (which exceeds the preset threshold range) is discarded and reobtained.

S303: continuing to execute the obtaining the current digital sample data by summing the first digital data and the second digital data and obtaining the arithmetic mean, if the first digital data and the second digital data are within the preset threshold range.

S304: returning to the collecting the first digital data and the second digital data of the current collection period, if the first digital data or the second digital data are without the preset threshold range.

The contents of steps S305-S306 are consistent with that of steps S103-S104, and the specific descriptions can refer to the related description of steps S103-S104 and are not described herein.

It can be known from this embodiment that, the first digital data and the second digital data are guaranteed to be stably within a certain range by limiting processing, and fluctuations of the first digital data and the second digital data caused by data instability which affects the accuracy of the digital data filtering method do not occur.

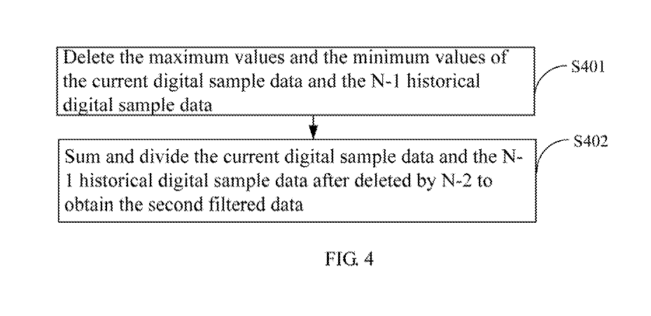

FIG. 4 is a flow chart of a digital data filtering method according to the other embodiment of the present disclosure, which is based on the above-mentioned embodiment. In the above-mentioned step S202, the second filtered data is obtained using the preset median value filtering algorithm according to the current digital sample data and the N−1 historical digital sample data. As shown in FIG. 4, the method includes the following steps.

S401: deleting the maximum values and the minimum values of the current digital sample data and the N−1 historical digital sample data.

In this embodiment, the N−1 historical digital sample data may be stored historical filter output data, or may be digital sample data having the same value with the current digital sample data.

Specifically, when it is possible to obtain the stored historical filter output data, it is determined that the N−1 historical digital sample data is the stored historical filter output data; when it is impossible to obtain the stored historical filter output data, it is determined that the N−1 historical digital sample data is the digital sample data having the same value with the current digital sample data.

S402: summing and dividing the current digital sample data and the N−1 historical digital sample data after deleted by N−2 to obtain the second filtered data.

In this embodiment, the current digital sample data and the N−1 historical digital sample data after deleted are summed and divided by N−2 to obtain an arithmetic mean.

In one embodiment of the present disclosure, determining the data change direction as an increasing direction, if the current digital sample data is greater than the digital sample data of the previous collection period;

determining the data change direction as a decreasing direction, if the current digital sample data is lesser than the digital sample data of the previous collection period; and

determining the absolute value of the difference between the current digital sample data and the digital sample data of the previous collection period as the data change acceleration of the current digital sample data.

In this embodiment, the data change direction is the decrement direction, which indicates that the current digital sample data is obtained by decreasing the digital sample data of the previous collection period. The data change acceleration of the current digital sample data An=|Dn−Do|, which represents the magnitude of the increasing or decreasing of the current digital sample data.

It can be seen from this embodiment that by comparing the current digital sample data with the pre-stored digital sample data of the previous collection period, the data change direction of the current digital sample data and the data change acceleration of the current digital sample data can be conveniently and quickly determined and to be used for subsequent calculation of the first filtered data and the second filtered data.

It should be understood that, the sequence of the serial numbers in each step of the above-mentioned embodiments does not mean the order of execution sequence, and the execution sequence of each process should be determined by its function and internal logic, and should not constitute any limitation on the implementation process of the embodiments of the present disclosure.

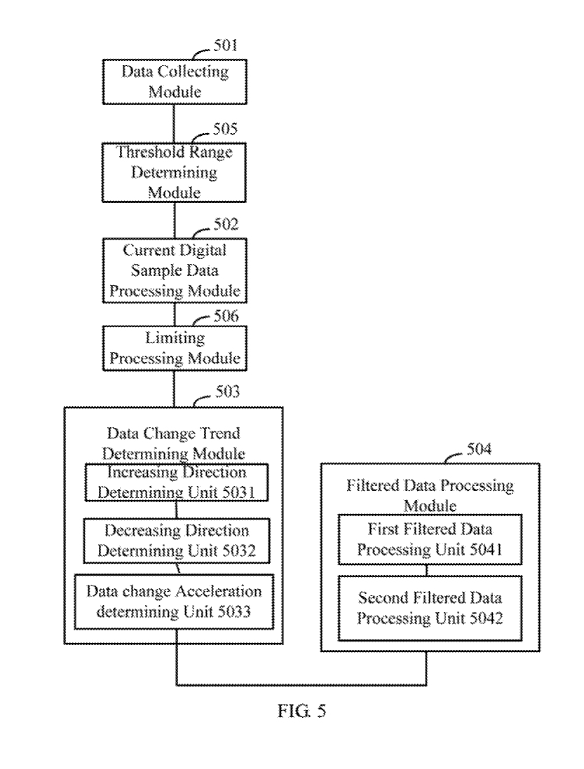

FIG. 5 is a schematic diagram of a digital data filtering apparatus according to the other embodiment of the present disclosure, which corresponds to the digital data filtering method of the above-mentioned embodiments. For ease of description, only the parts related to this embodiment are shown. As shown in FIG. 5, the apparatus includes a data collecting module 501, a current digital sample data processing module 502, a data change trend determining module 503, and a filtered data processing module 504.

The data collecting module 501 is configured to collect first digital data and second digital data of a current collection period.

The current digital sample data processing module 502 is configured to obtain a current digital sample data by summing the first digital data and the second digital data and obtaining an arithmetic mean.

The data change trend determining module 503 is configured to determine a data change trend of the current digital sample data according to the current digital sample data and a digital sample data of a previous collection period.

The filtered data processing module 504 is configured to choose a filtering method from a group of prestored filtering methods according to the data change trend, and filter the current digital sample data using the filtering method to obtain a filtered data.

It can be known from this embodiment that the present disclosure can realize the filtering of digital data in different interference scenes which improves the anti-interference capability of digital data filtering by: collecting first digital data and second digital data of a current collection period; obtaining a current digital sample data by summing the first digital data and the second digital data and obtaining an arithmetic mean; determining a data change trend of the current digital sample data according to the current digital sample data and a digital sample data of a previous collection period; and determining a filtering method according to the data change trend, and filtering the current digital sample data using the filtering method to obtain filtered data.

As shown in FIG. 5, the data change trend includes a data change direction and a data change acceleration, and the filtered data processing module 504 includes:

a first filtered data processing unit 5041 configured to obtain first filtered data using a preset weighted recursive filtering algorithm based on the current digital sample data and N−1 historical digital sample data, if the data change direction is consistent with a previous data change direction corresponding to the digital sample data of the previous collection period, or the data change acceleration is greater than a preset acceleration threshold, where N is a positive integer; and

a second filtered data processing unit 5042 configured to obtain second filtered data using a preset median value filtering algorithm based on the current digital sample data and the N−1 historical digital sample data, if the data change direction is inconsistent with the previous data change direction corresponding to the digital sample data of the previous collection period and the data change acceleration is not greater than the preset acceleration threshold, where N is a positive integer.

As shown in FIG. 5, basing on the above-mentioned embodiment, the apparatus further includes: a threshold range determining module 505 configured to determine whether the first digital data and the second digital data are all within a preset threshold range after the data collecting module 501.

The current digital sample data processing module 502 is further configured to continue to execute the obtaining the current digital sample data by summing the first digital data and the second digital data and obtaining the arithmetic mean, if the first digital data and the second digital data are within the preset threshold range.

The data collecting module 501 is further configured to return to the collecting the first digital data and the second digital data of the current collection period, if the first digital data or the second digital data are without the preset threshold range.

As shown in FIG. 5, basing on the above-mentioned embodiment, the first filtered data processing unit 5041 is specifically configured to:

assuming the current digital sample data is D_{N}, and the N−1 historical digital sample data are respectively D₁, D₂, . . . , and D_{N-1}, wherein D₁, D₂, . . . , and D_{N-1} are in the order of collection;

determining first filtered data O, wherein

$$O = ( {\sum }_{i = 1}^{N} ki * {D}_{i} ) / {\sum }_{i = 1}^{N} ki ,$$

i is 1, 2, 3, . . . , and N, and weighting factor ki=2ⁱ, if the data change direction is consistent with the previous data change direction corresponding to the digital sample data of the previous collection period and the data change acceleration is greater than the preset acceleration threshold; and

determining the first filtered data O, wherein

$$O = ( {\sum }_{i = 1}^{N} ki * {D}_{i} ) / {\sum }_{i = 1}^{N} ki ,$$

i is 1, 2, 3, . . . , and N, and weighting factor ki=i, if the data change direction is consistent with the previous data change direction corresponding to the digital sample data of the previous collection period and the data change acceleration is not greater than the preset acceleration threshold, or if the data change direction is inconsistent with the previous data change direction corresponding to the digital sample data of the previous collection period and the data change acceleration is greater than the preset acceleration threshold.

As shown in FIG. 5, basing on the above-mentioned embodiment, the second filtered data processing unit 5042 is specifically configured to delete the maximum values and the minimum values of the current digital sample data and the N−1 historical digital sample data; and sum and divide the current digital sample data and the N−1 historical digital sample data after deleted by N−2 to obtain the second filtered data.

As shown in FIG. 5, basing on the above-mentioned embodiment, the data change trend determining module 503 includes:

an increasing direction determining unit 5031 configured to determine the data change direction as an increasing direction, if the current digital sample data is greater than the digital sample data of the previous collection period;

a decreasing direction determining unit 5032 configured to determine the data change direction as a decreasing direction, if the current digital sample data is lesser than the digital sample data of the previous collection period; and

a data change acceleration determining unit 5033 configured to determine the absolute value of the difference between the current digital sample data and the digital sample data of the previous collection period as the data change acceleration of the current digital sample data.

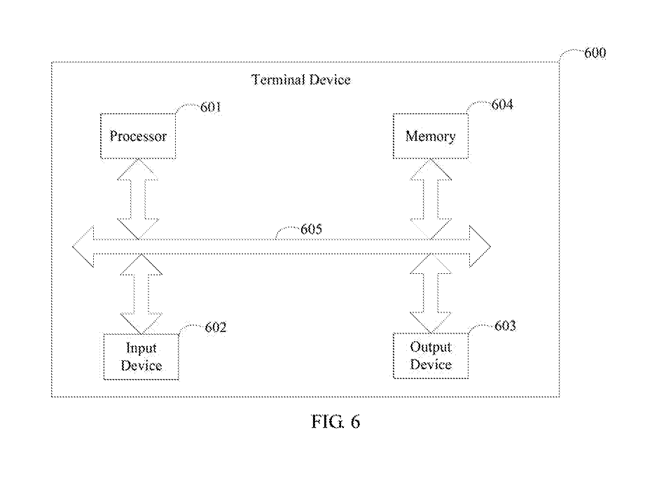

FIG. 6 is a schematic diagram of a digital data filtering terminal device according to the other embodiment of the present disclosure. As shown in FIG. 6, a terminal device 600 of this may include one or more processors 601, one or more input devices 602, one or more output devices 603, and one or more memories 604. The processor 601, the input device 602, the output device 603, and the memory 604 communicate with each other through a communication bus 605. The memory 604 is configured to store computer programs including instructions. The processor 601 is configured to execute the instructions stored in the memory 604.

The processor 601 is configured to collect first digital data and second digital data of a current collection period; obtain a current digital sample data by summing the first digital data and the second digital data and obtaining an arithmetic mean; determine a data change trend of the current digital sample data according to the current digital sample data and a digital sample data of a previous collection period; and choose a filtering method from a group of restored filtering methods according to the data change trend, and filter the current digital sample data using the filtering method to obtain filtered data.

Furthermore, the data change trend includes a data change direction and a data change acceleration. The processor 601 is further configured to: obtain first filtered data using a preset weighted recursive filtering algorithm based on the current digital sample data and N−1 historical digital sample data, if the data change direction is consistent with a previous data change direction corresponding to the digital sample data of the previous collection period, or the data change acceleration is greater than a preset acceleration threshold, where N is a positive integer; and

obtain second filtered data using a preset median value filtering algorithm based on the current digital sample data and the N−1 historical digital sample data, if the data change direction is inconsistent with the previous data change direction corresponding to the digital sample data of the previous collection period and the data change acceleration is not greater than the preset acceleration threshold, where N is a positive integer.

Furthermore, the processor 601 is further configured to determine whether the first digital data and the second digital data are all within a preset threshold range; continue to execute the obtaining a current digital sample data by summing the first digital data and the second digital data and obtaining the arithmetic mean, if the first digital data and the second digital data are within the preset threshold range; and return to the collecting the first digital data and the second digital data of the current collection period, if the first digital data or the second digital data are without the preset threshold range. Furthermore, the processor 601 is further configured to assume the current digital sample data is D_{N}, and the N−1 historical digital sample data are respectively D₁, D₂, . . . , and D_{N-1}, wherein D₁, D₂, . . . , and D_{N-1} are in the order of collection; and determine first filtered data O, wherein

$$O = ( {\sum }_{i = 1}^{N} ki * {D}_{i} ) / {\sum }_{i = 1}^{N} ki ,$$

i is 1, 2, 3, . . . , and N, and weighting factor ki=2ⁱ, if the data change direction is consistent with the previous data change direction corresponding to the digital sample data of the previous collection period and the data change acceleration is greater than the preset acceleration threshold; and determine the first filtered data O, wherein

$$O = ( {\sum }_{i = 1}^{N} ki * {D}_{i} ) / {\sum }_{i = 1}^{N} ki ,$$

i is 1, 2, 3 . . . , and N, and weighting factor ki=i, if the data change direction is consistent with the previous data change direction corresponding to the digital sample data of the previous collection period and the data change acceleration is not greater than the preset acceleration threshold, or if the data change direction is inconsistent with the previous data change direction corresponding to the digital sample data of the previous collection period and the data change acceleration is greater than the preset acceleration threshold.

Furthermore, the processor 601 is further configured to delete the maximum values and the minimum values of the current digital sample data and the N−1 historical digital sample data; and sum and dividing the current digital sample data and the N−1 historical digital sample data after deleted by N−2 to obtain the second filtered data.

Furthermore, the processor 601 is further configured to: determine the data change direction as an increasing direction, if the current digital sample data is greater than the digital sample data of the previous collection period; determine the data change direction as a decreasing direction, if the current digital sample data is lesser than the digital sample data of the previous collection period; and determine the absolute value of the difference between the current digital sample data and the digital sample data of the previous collection period as the data change acceleration of the current digital sample data.

It should be understood that, in the embodiment of the present disclosure, the processor 601 may be a central processing unit (CPU), or be other general purpose processor, a digital signal processor (DSP), an application specific integrated circuit (ASIC), a field-programmable gate array (FPGA), or be other programmable logic device, a discrete gate, a transistor logic device, and a discrete hardware component. The general purpose processor may be a microprocessor, or the processor may also be any conventional processor.

The input device 602 may include a touchpad, a fingerprint acquisition sensor (for acquiring fingerprint information of the user and direction information of the fingerprint), a microphone, and the like. The output device 603 may include a display (e.g., LCD), a speaker, and the like.

The memory 604 may include a read-only memory and a random access memory, which provides the processor 601 with instructions and data. A portion of the memory 604 may also include a non-volatile random access memory. The memory 604 may also store device type information.

In a specific implementation, the processor 601, the input device 602, and the output device 603 described in this embodiment can execute the implementations described in the embodiments of the method provided by the present disclosure, and can also execute the implementations of the terminal device described in the embodiments of the present disclosure, which are not described herein.

In another embodiment of the present disclosure, a non-transitory computer-readable storage medium is provided. The computer-readable storage medium stores one or more computer programs. The one or more computer programs include instructions. When the instructions are executed by a processor, all or part of the processes in the method of the above-mentioned embodiments are implemented, and all or part of the processes may also be implemented by instructing relevant hardware through the one or more computer programs. The computer program may be stored in a non-transitory computer-readable storage medium, which may implement the steps of each of the above-mentioned method embodiments when executed by a processor. In which, the computer program includes computer program codes which may be the form of source codes, object codes, executable files, certain intermediate, and the like. The compute-readable medium may include any primitive or device capable of carrying the computer program codes, a recording medium, a USB3 flash drive, a portable hard disk, a magnetic disk, an optical disk, a computer memory, a read-only memory (ROM), a random access memory (RAM), electric carrier signals, telecommunication signals and software distribution media. It should be noted that the content contained in the computer readable medium may be appropriately increased or decreased according to the requirements of legislation and patent practice in the jurisdiction. For example, in some jurisdictions, according to the legislation and patent practice, a computer readable medium does not include electric carrier signals and telecommunication signals.

The computer-readable storage medium may be an internal storage unit of the terminal device of any of the above-mentioned embodiments, for example, a hard disk or a memory of the terminal device. The computer-readable storage medium may also be an external storage device of the terminal device, for example, a plug-in hard disk, a smart media card (SMC), a secure digital (SD) card, flash card, and the like, which is equipped on terminal device. Furthermore, the computer-readable storage medium may further include both an internal storage unit and an external storage device, of the terminal device. The computer-readable storage medium is configured to store the computer program and other programs and data required by the terminal device. The computer-readable storage medium may also be used to temporarily store data that has been or will be output.

Those ordinary skilled in the art may clearly understand that, the exemplificative units and steps described in the embodiments disclosed herein may be implemented through electronic hardware, computer software, or a combination of both. In order to clearly illustrate the interchangeability of hardware and software, the compositions and steps of the examples have been generally described according to functions in the above-mentioned descriptions. Whether these functions are implemented through hardware or software depends on the specific application and design constraints of the technical schemes. Those ordinary skilled in the art may implement the described functions in different manners for each particular application, while such implementation should not be considered as beyond the scope of the present disclosure.

Those skilled in the art can clearly understand that, for the convenience and conciseness of the description, the specific operation process of the above-mentioned terminal device and unit may refer to the corresponding process in the above-mentioned method embodiment, which are not described herein.

In the several embodiments provided by the present disclosure, it should be understood that, the disclosed terminal device and method may be implemented in other manners. For example, the device embodiments described above are merely illustrative. For example, the division of the units is merely a logical functional division, and other division manner may be used in actual implementations, that is, multiple units or components may be combined or be integrated into another system, or some of the features may be ignored or not performed. In addition, the shown or discussed mutual coupling may be direct coupling or communication connection, and may also be indirect coupling or communication connection through some interfaces, devices or units, and may also be electrical, mechanical or other forms.

The units described as separate components may or may not be physically separated. The components represented as units may or may not be physical units, that is, may be located in one place or be distributed to multiple network units. Some or all of the units may be selected according to actual needs to achieve the objectives of this embodiment.

In addition, each functional unit in each of the embodiments of the present disclosure may be integrated into one processing unit, or each unit may exist alone physically, or two or more units may be integrated in one unit. The above-mentioned integrated unit may be implemented in the form of hardware or in the form of software functional unit.

The foregoing descriptions are merely specific implementation manners of the present disclosure, but the protection scope of the present disclosure is not limited thereto. Any person skilled in the art can easily conceive various equivalent modifications or substitutions within the technical scope disclosed by the present disclosure. The modifications or substitutions should be included in the protection scope of the present disclosure. Therefore, the protection scope of the present disclosure shall be subject to the protection scope of the claims.

What is claimed is:

1. A computer-implemented digital data filtering method, comprising executing on a processor steps of:
collecting, using a sensor, first digital data and second digital data selected from a group consisting of a distance, temperature, humidity, pressure, current, and voltage, during a current collection period;
obtaining a current digital sample data by summing the first digital data and the second digital data and obtaining an arithmetic mean;
determining a data change trend of the current digital sample data according to the current digital sample data and a digital sample data of a previous collection period; and
determining a filtering method according to the data change trend, and filtering the current digital sample data using the filtering method to obtain filtered data.

2. The method of claim 1, wherein the data change trend comprises a data change direction and a data change acceleration;
the step of determining the filtering method according to the data change trend, and filtering the current digital sample data using the filtering method to obtain the filtered data comprises:
obtaining first filtered data using a preset weighted recursive filtering algorithm based on the current digital sample data and N−1 historical digital sample data, in response to the data change direction of the current digital sample being consistent with a previous data change direction of the previous digital sample data of the previous collection period, or the data change acceleration being greater than a preset acceleration threshold, wherein N is a positive integer; or
obtaining a second filtered data using a preset median value filtering algorithm based on the current digital sample data and the N−1 historical digital sample data, in response to the data change direction being inconsistent with the previous data change direction corresponding to the digital sample data of the previous collection period and the data change acceleration being not greater than the preset acceleration threshold, wherein N is a positive integer.

3. The method of claim 1, after the step of collecting the first digital data and the second digital data of the current collection period further comprises:
determining whether the first digital data and the second digital data are all within a preset threshold range;
continuing to execute the obtaining the current digital sample data by summing the first digital data and the second digital data and obtaining the arithmetic mean, in response to the first digital data and the second digital data being within the preset threshold range; and
returning to the collecting the first digital data and the second digital data of the current collection period, in response to the first digital data or the second digital data being without the preset threshold range.

4. The method of claim 2, the step of obtaining the first filtered data using the preset weighted recursive filtering algorithm according to the current digital sample data and the N−1 historical digital sample data, in response to the data change direction being consistent with the previous data change direction corresponding to the digital sample data of the previous collection period, or the data change acceleration being greater than the preset acceleration threshold comprises:
assuming the current digital sample data is D_{N}, and the N−1 historical digital sample data are respectively D₁, D₂, . . . , and D_{N-1}, wherein D₁, D₂, . . . , and D_{N-1} are in the order of collection;
determining first filtered data O, wherein
$$O = ( {\sum }_{i = 1}^{N} ki * {D}_{i} ) / {\sum }_{i = 1}^{N} ki ,$$
i is 1, 2, 3, . . . , and N, and weighting factor ki=2ⁱ, in response to the data change direction being consistent with the previous data change direction corresponding to the digital sample data of the previous collection period and the data change acceleration being greater than the preset acceleration threshold; and
determining the first filtered data O, wherein
$$O = ( {\sum }_{i = 1}^{N} ki * {D}_{i} ) / {\sum }_{i = 1}^{N} ki ,$$
i is 1, 2, 3, . . . , and N, and weighting factor ki=i, in response to the data change direction being consistent with the previous data change direction corresponding to the digital sample data of the previous collection period and the data change acceleration being not greater than the preset acceleration threshold, or in response to the data change direction being inconsistent with the previous data change direction corresponding to the digital sample data of the previous collection period and the data change acceleration being greater than the preset acceleration threshold.

5. The method of claim 2, the step of obtaining the second filtered data using the preset median value filtering algorithm according to the current digital sample data and the N−1 historical digital sample data comprises:
deleting the maximum values and the minimum values of the current digital sample data and the N−1 historical digital sample data; and
summing and dividing the current digital sample data and the N−1 historical digital sample data after deleted by N−2 to obtain the second filtered data.

6. The method of claim 2, the step of determining the data change trend of the current digital sample data according to the current digital sample data and the digital sample data of the previous collection period comprises:
determining the data change direction as an increasing direction, in response to the current digital sample data being greater than the digital sample data of the previous collection period;
determining the data change direction as a decreasing direction, in response to the current digital sample data being lesser than the digital sample data of the previous collection period; and
determining the absolute value of the difference between the current digital sample data and the digital sample data of the previous collection period as the data change acceleration of the current digital sample data.

7. The method of claim 1, further comprising:
outputting the filtered data to a robot for operating the robot based on the filtered data.

8. A digital data filtering apparatus comprising a processor and a memory storing instructions executable for the processor, wherein the instructions function as:
a data collecting module configured to collect first digital data and second digital data of a current collection period;
a current digital sample data processing module configured to obtain a current digital sample data by summing the first digital data and the second digital data and obtaining an arithmetic mean;
a data change trend determining module configured to determine a data change trend of the current digital sample data according to the current digital sample data and a digital sample data of a previous collection period; and
a filtered data processing module configured to choose a filtering method from a group of prestored filtering methods according to the data change trend, and filter the current digital sample data using the filtering method to obtain a filtered data.

9. The apparatus of claim 8, wherein the data change trend comprises a data change direction and a data change acceleration, the filtered data processing module comprises:
a first filtered data processing unit configured to obtain first filtered data using a preset weighted recursive filtering algorithm based on the current digital sample data and N−1 historical digital sample data, in response to the data change direction being consistent with a previous data change direction corresponding to the digital sample data of the previous collection period, or the data change acceleration being greater than a preset acceleration threshold, wherein N is a positive integer; and
a second filtered data processing unit configured to obtain a second filtered data using a preset median value filtering algorithm based on the current digital sample data and the N−1 historical digital sample data, in response to the data change direction being inconsistent with the previous data change direction corresponding to the digital sample data of the previous collection period and the data change acceleration being not greater than the preset acceleration threshold, wherein N is a positive integer.

10. The apparatus of claim 8, further comprising a threshold range determining module configured to determine whether the first digital data and the second digital data are all within a preset threshold range after the data collecting module; wherein:
the current digital sample data processing module is further configured to continue to execute the obtaining the current digital sample data by summing the first digital data and the second digital data and obtaining the arithmetic mean, in response to the first digital data and the second digital data being within the preset threshold range; and
the data collecting module is further configured to return to the collecting the first digital data and the second digital data of the current collection period, in response to the first digital data or the second digital data being without the preset threshold range.

11. The apparatus of claim 9, wherein the first filtered data processing unit is configured to:
assume the current digital sample data is D_{N}, and the N−1 historical digital sample data are respectively D₁, D₂, . . . , and D_{N-1}, wherein D₁, D₂, . . . , and D_{N-1} are in the order of collection;
determine first filtered data O, wherein
$$O = ( {\sum }_{i = 1}^{N} ki * {D}_{i} ) / {\sum }_{i = 1}^{N} ki ,$$
i is 1, 2, 3, . . . , and N, and weighting factor ki=2ⁱ, in response to the data change direction being consistent with the previous data change direction corresponding to the digital sample data of the previous collection period and the data change acceleration being greater than the preset acceleration threshold; and
determine the first filtered data O, wherein
$$O = ( {\sum }_{i = 1}^{N} ki * {D}_{i} ) / {\sum }_{i = 1}^{N} ki ,$$
i is 1, 2, 3, . . . , and N, and weighting factor ki=i, in response to the data change direction being consistent with the previous data change direction corresponding to the digital sample data of the previous collection period and the data change acceleration being not greater than the preset acceleration threshold, or in response to the data change direction being inconsistent with the previous data change direction corresponding to the digital sample data of the previous collection period and the data change acceleration being greater than the preset acceleration threshold.

12. The apparatus of claim 9, wherein the second filtered data processing unit is configured to:
delete the maximum values and the minimum values of the current digital sample data and the N−1 historical digital sample data; and
sum and dividing the current digital sample data and the N−1 historical digital sample data after deleted by N−2 to obtain the second filtered data.

13. The apparatus of claim 9, the data change trend determining module comprises:
an increasing direction determining unit configured to determine the data change direction as an increasing direction, in response to the current digital sample data being greater than the digital sample data of the previous collection period;
a decreasing direction determining unit configured to determine the data change direction as a decreasing direction, in response to the current digital sample data being lesser than the digital sample data of the previous collection period; and
a data change acceleration determining unit configured to determine the absolute value of the difference between the current digital sample data and the digital sample data of the previous collection period as the data change acceleration of the current digital sample data.

14. A terminal device for digital data filtering, comprising:
one or more processors;
a memory; and
one or more programs, wherein the one or more programs are stored in the memory and configured to be executed by the one or more processors, the one or more programs comprises:
instructions for collecting first digital data and second digital data of a current collection period;
instructions for obtaining a current digital sample data by summing the first digital data and the second digital data and obtaining an arithmetic mean;
instructions for determining a data change trend of the current digital sample data according to the current digital sample data and a digital sample data of a previous collection period; and
instructions for choosing a filtering method from a group of restored filtering methods according to the data change trend, and filtering the current digital sample data using the filtering method to obtain a filtered data.

15. The terminal device of claim 14, wherein the data change trend comprises a data change direction and a data change acceleration;
the instructions for determining the filtering method according to the data change trend, and filtering the current digital sample data using the filtering method to obtain the filtered data comprises:
instructions for obtaining first filtered data using a preset weighted recursive filtering algorithm based on the current digital sample data and N−1 historical digital sample data, in response to the data change direction being consistent with a previous data change direction corresponding to the digital sample data of the previous collection period, or the data change acceleration being greater than a preset acceleration threshold, wherein N is a positive integer, and
instructions for obtaining a second filtered data using a preset median value filtering algorithm based on the current digital sample data and the N−1 historical digital sample data, in response to the data change direction being inconsistent with the previous data change direction corresponding to the digital sample data of the previous collection period and the data change acceleration being not greater than the preset acceleration threshold, wherein N is a positive integer.

16. The terminal device of claim 14, after the instructions for collecting the first digital data and the second digital data of the current collection period further comprises:
instructions for determining whether the first digital data and the second digital data are all within a preset threshold range;
instructions for continuing to execute the obtaining the current digital sample data by summing the first digital data and the second digital data and obtaining the arithmetic mean, in response to the first digital data and the second digital data being within the preset threshold range; and
instructions for returning to the collecting the first digital data and the second digital data of the current collection period, in response to the first digital data or the second digital data being without the preset threshold range.

17. The terminal device of claim 15, the instructions for obtaining the first filtered data using the preset weighted recursive filtering algorithm according to the current digital sample data and the N−1 historical digital sample data, in response to the data change direction being consistent with the previous data change direction corresponding to the digital sample data of the previous collection period, or the data change acceleration being greater than the preset acceleration threshold comprises:
instructions for assuming the current digital sample data is D_{N}, and the N−1 historical digital sample data are respectively D₁, D₂, . . . , and D_{N-1}, wherein D₁, D₂, . . . , and D_{N-1} are in the order of collection;
instructions for determining first filtered data O, wherein
$$O = ( {\sum }_{i = 1}^{N} ki * {D}_{i} ) / {\sum }_{i = 1}^{N} ki ,$$
i is 1, 2, 3, . . . , and N, and weighting factor ki=2ⁱ, in response to the data change direction being consistent with the previous data change direction corresponding to the digital sample data of the previous collection period and the data change acceleration being greater than the preset acceleration threshold; and
instructions for determining the first filtered data O, wherein
$$O = ( {\sum }_{i = 1}^{N} ki * {D}_{i} ) / {\sum }_{i = 1}^{N} ki ,$$
i is 1, 2, 3, . . . , and N, and weighting factor ki=i, in response to the data change direction being consistent with the previous data change direction corresponding to the digital sample data of the previous collection period and the data change acceleration being not greater than the preset acceleration threshold, or in response to the data change direction being inconsistent with the previous data change direction corresponding to the digital sample data of the previous collection period and the data change acceleration being greater than the preset acceleration threshold.

18. The terminal device of claim 15, the instructions for obtaining the second filtered data using the preset median value filtering algorithm according to the current digital sample data and the N−1 historical digital sample data comprises:
instructions for deleting the maximum values and the minimum values of the current digital sample data and the N−1 historical digital sample data; and
instructions for summing and dividing the current digital sample data and the N−1 historical digital sample data after deleted by N−2 to obtain the second filtered data.

19. The terminal device of claim 15, the instructions for determining the data change trend of the current digital sample data according to the current digital sample data and the digital sample data of the previous collection period comprises:
instructions for determining the data change direction as an increasing direction, in response to the current digital sample data being greater than the digital sample data of the previous collection period;
instructions for determining the data change direction as a decreasing direction, in response to the current digital sample data being lesser than the digital sample data of the previous collection period; and
instructions for determining the absolute value of the difference between the current digital sample data and the digital sample data of the previous collection period as the data change acceleration of the current digital sample data.
